(19) United States
(12) Patent Application Publication
(10) Pub. No.: US 2003/0228495 A1
(43) Pub. Date: Dec. 11, 2003

(54) Magnetic recording medium and manufacturing method thereof

(76) Inventors: Yoshiyuki Kuboki, Kanagawa (JP); Akihiro Otsuki, Nagano (JP); Hiroyuki Uwazumi, Nagano (JP)

Correspondence Address: ROSSI & ASSOCIATES, P.O. Box 826, Ashburn, VA, 20146-0826, US

(21) Appl. No.: 10/426,932

(22) Filed: Apr. 30, 2003

(30) Foreign Application Priority Data
May 1, 2002 (JP) 2002-130143

(51) Int. Cl. G11B 5/66

(52) U.S. Cl. 428/694 BS; 428/694 R

(57) ABSTRACT

A magnetic recording medium and a manufacturing method thereof can be formed or carried out without substrate heating. The magnetic recording medium has a seed layer of a nonmagnetic material having a bcc structure that has (211) orientation formed on a nonmagnetic substrate, an underlayer of a nonmagnetic material having a bcc structure that is different to that of the seed layer 102 and having (211) preferential orientation formed on the seed layer, an intermediate layer of a nonmagnetic material having an hcp structure that has (100) preferential orientation formed on the underlayer, and a magnetic layer of an hcp CoCr alloy that has (100) preferential orientation formed on the intermediate layer.

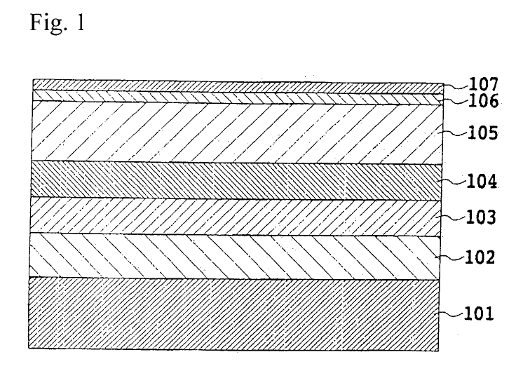

### BACKGROUND

In recent years, there have been rapid advances in increasing the recording density of magnetic recording media. Presently, high density recording media, which typically use an NiP-plated Al substrate or a glass substrate, a CoCr alloy recording layer provided on Cr and a Cr alloy, use a longitudinal recording method, where recording is carried out with the direction of recording magnetization oriented in-plane.

To increase the track recording density in the case of the longitudinal recording method, it is necessary to increase the coercivity by reducing the product (Mr·t) of the remnant magnetization (Mr) and the thickness (t) of the magnetic layer in the recording medium to reduce the influence of a diamagnetic field during recording. Moreover, to reduce medium noise arising from a magnetization transition region, it is necessary to make the magnetic layer crystal grains minute, and to reduce exchange interaction between the crystal grains, thus reducing the activation volume.

However, a medium in which the activation volume has been reduced by making the magnetic layer crystal grains minute and reducing the inter-grain interaction has poor thermal stability, and there is a drop in the remanent magnetization, accompanied by an increase in the magnetic transition width. As a result, the thermal fluctuation accelerates the drop over time of the head output. Increasing the magnetic anisotropy energy (Ku) of the magnetic layer is effective for suppressing this thermal fluctuation. Presently, the magnetic anisotropy energy is increased by adding a large amount of Pt to the CoCr alloy.

With an ordinary longitudinal recording medium that uses an Al or glass substrate and a CoCr alloy magnetic layer, to improve the stability to thermal fluctuation while making the grain size minute and reducing the inter-grain interaction, and thus reducing the activation volume, it is necessary to optimize the magnetic layer composition, the underlayer material and so on. Making the underlayer thin and using multilayered underlayer are effective for making the grain size minute. For reducing the inter-grain interaction, it is effective to segregate the Cr in the CoCr alloy to crystal grain boundaries by carrying out substrate heating, thus forming nonmagnetic regions.

For example, Japanese Patent Application Laid-open No. 2000-99944 discloses a method of manufacturing a magnetic recording medium where the substrate is maintained at a high temperature, and an LiF film, a Cr film, and a Co-Cr-Pt film are formed in this order on the substrate. However, the addition of a large amount of Pt inhibits the segregation of Cr to crystal grain boundaries in the magnetic layer that promotes reduction of the inter-grain exchange interaction, thereby increasing noise. Thus, it is difficult to select a composition that gives both low noise and low thermal fluctuation.

Moreover, by changing the amount of Pt added, the lattice parameters of the CoCr alloy magnetic layer change, and hence there is a deterioration in the degree to which the c-axis of the CoCr alloy magnetic layer is oriented parallel to the substrate plane. Thus, there is also deterioration in the coercivity, and the composition of the underlayer and the film deposition process also must be adjusted accordingly.

Furthermore, when using a plastic substrate, substrate heating cannot take place during the film deposition. As conventional so-called Al and glass substrate processes cannot be used with the plastic substrates, it is difficult to manufacture a magnetic recording medium having a high recording density.

There is a need for a magnetic recording medium and a manufacturing method thereof that results in high coercivity, low noise, and excellent thermal fluctuation stability, without carrying out substrate heating. The present invention addresses this need.

### SUMMARY OF THE INVENTION

The present invention relates to a magnetic recording medium and a method of manufacturing the magnetic recording medium, such as an HDD (hard disk drive) of a PC (personal computer), network terminal equipment, AV equipment or the like.

One aspect of the present invention is a magnetic recording medium comprising a nonmagnetic substrate, a seed layer, an underlayer, and a magnetic layer. The substrate can be composed of a nonmagnetic material having a bcc structure having (211) orientation. The underlayer, which is formed on the seed layer, can be composed of a nonmagnetic material having a bcc structure that is different from that of the seed layer, and having (211) preferential orientation. The intermediate layer, which is formed on the underlayer, can be composed of a nonmagnetic material having an hcp structure having (100) preferential orientation. The magnetic layer, which is formed on the intermediate layer, can be composed of an hcp CoCr alloy having (100) preferential orientation.

These layers are formed without heating the substrate. The resulting recording medium has a coercivity, an S/N ratio, and a thermal stability that are comparable to or better than those of magnetic recording media manufactured using a conventional method that includes a substrate heating process.

Here, the bce structure of the seed layer can be a B2 structure. The seed layer can have a thickness of 1 to 30 nm. The nonmagnetic substrate can be a substrate selected from the group consisting of NiP-plated Al substrates, glass substrates, and plastic substrates. The underlayer can be composed of a nonmagnetic alloy having as a principal component thereof at least one element selected from the group consisting of Ta, Nb, V, Mo, Cr, Ti, W, and Mn. The seed layer can have as a principal component thereof an intermetallic compound selected from the group consisting of CoHf, CoSc, CoTi, CoZr, CuZr, CuSc, MgRh, FeTi, FeRh, NiSc, NiTi, and RuZr. The intermediate layer can have as a principal component thereof at least one element selected from the group consisting of Ru, Re, Os, and Tc. Alternatively, the intermediate layer can have as a principal component thereof an intermetallic compound of a composition selected from the group consisting of WRh3, Ni3Sn, Ni3Zr, Co3W, NiIn, TiAl, Co3C, CuZn, and MnZn. The magnetic layer can have a CoCr alloy as a principal component thereof, to contain 5 to 20% of a nonmetallic element or a nonmetallic compound as a molar ratio relative to Co, and to contain 10 to 50% of Pt as an atomic ratio relative to Co.

Another aspect of the present invention is a method of manufacturing the previously described magnetic recording medium, where on the nonmagnetic substrate, forming the seed layer, on the seed layer forming the underlayer, on the underlayer forming intermediate layer, and on the intermediate layer forming the magnetic layer.

Here, at least one of the seed layer, underlayer, intermediate layer, and magnetic layer is formed without heating the nonmagnetic substrate.

### BRIEF DESCRIPTION OF THE DRAWINGS

The FIGURE is a sectional view of a magnetic recording medium according to an embodiment of the present invention.

### DETAILED DESCRIPTION

Following is a detailed description of an embodiment of the present invention, with reference to the Figure. In the following explanation, ‘(hkl) orientation’ means that the planes represented by the Miller indices (hkl) are included in the planes oriented parallel to the substrate plane. Moreover, ‘(hkl) preferential orientation’ means that virtually all of the planes oriented parallel to the substrate plane are planes represented by the Miller indices (hkl). Moreover ‘principal component’ means a component whose content is at least approximately 50% in terms of atomic ratio or molar ratio.

The Figure is a sectional view of a magnetic recording medium according to the present embodiment. In the magnetic recording medium, a seed layer 102 composed of a nonmagnetic material having a bee structure that has (211) orientation is formed on a nonmagnetic substrate 101. An underlayer 103 composed of a nonmagnetic material having a bce structure that is different to that of the seed layer 102 and having (211) preferential orientation is formed on the seed layer 102. An intermediate layer 104 composed of a nonmagnetic material having an hcp structure that has (100) preferential orientation is formed on the underlayer 103. A magnetic layer 105 composed of an hcp CoCr alloy that has (100) preferential orientation is formed on the intermediate layer 104. Furthermore, a protective layer 106 composed of a carbon-based compound, and a liquid lubricant layer 107 are formed in this order on the magnetic layer 105.

The nonmagnetic substrate 101 can be can be composed of NiP-plated Al substrates, glass substrates, and plastic substrates. The seed layer 102 can be composed of as a principal component thereof an intermetallic compound selected from CoHf, CoSc, CoTi, CoZr, CuZr, CuSc, MgRh, FeTi, FeRh, NiSc, NiTi, and RuZr. Moreover, the seed layer 102 can have a thickness of 1 to 30 nm. The underlayer 103 can be composed of a nonmagnetic alloy having as a principal component thereof a metal selected from Ta, Nb, V, Mo, Cr, Ti, W, and Mn. The intermediate layer 104 can be composed of as a principal component thereof a metal selected from Ru, Re, Os, and Tc. Alternatively, the intermediate layer 104 preferably can be composed of as a principal component thereof an intermetallic compound of a composition selected from WRh3, Ni3Sn, Ni3Zr, Co3W, NiIn, TiAl, Co3C, CuZn, and MnZn. The magnetic layer 105 can be composed of a CoCr alloy as a principal component thereof, containing 5 to 20% of a nonmetallic element or a nonmetallic compound as a molar ratio relative to Co, and containing 10 to 50% of Pt as an atomic ratio relative to Co. The protective layer 106 is for protecting the magnetic layer 105 and/or a magnetic head. For example, a carbon-based protective layer can be used. The liquid lubricant layer 107, for example, can be a fluorocarbon-type lubricant.

When manufacturing the magnetic recording medium according to the present embodiment, the seed layer 102 is formed on the nonmagnetic substrate 101. Next, the underlayer 103 is formed on the seed layer 102. Next, the intermediate layer 104 is formed on the underlayer 103. Next, the magnetic layer is formed on the intermediate layer.

In the case of carrying out the film deposition on the nonmagnetic substrate 101 using sputtering or the like without heating the nonmagnetic substrate 101, the crystal planes in which the atoms are most closely packed tend to undergo preferential orientation. Cr and Cr alloys have a bee structure, and the (110) planes correspond to the most closely packed planes, and hence the (110) planes readily orient parallel to the substrate plane. It is thus preferable to form at least one of the seed layer 102, underlayer 103, intermediate layer 104, and magnetic layer 105 without heating the nonmagnetic substrate 101.

Here, it will be assumed that the seed layer 102 is made to be Cr, the intermediate layer 104 is made to be pure Co, and the Co is made to grow on a (110) plane of the Cr. In this case, from the viewpoint of consistency of the crystal plane spacing, it is thought that (101) planes or (100) planes of the Co will grow. The unit cells of the various planes are considered to be rectangular, and the lengths of the short sides and long sides thereof are as follows:

Cr (110) planes: short side 2.88 Å, long side 4.07 Å

Co (101) planes: short side 2.50 Å, long side 4.33 Å

Co (100) planes: short side 2.50 Å, long side 4.07 Å

As can be seen from these values, when the Cr (110) planes are preferentially oriented, one would think that Co (100) planes will grow more preferentially than Co (101) planes. Co (100) planes are crystal planes that are parallel to the c-axis, and hence, it is thought that if these planes are preferentially oriented, then the c-axis will be preferentially oriented parallel to the substrate plane. It is thought that if the c-axis of the intermediate layer 104 can be preferentially oriented parallel to the substrate plane in this way, then it will become possible for the c-axis of the hcp CoCr alloy formed thereon to also be preferentially oriented parallel to the substrate plane. In actual practice, the magnetic layer 105 is an alloy, and the lattice parameters are larger than those of pure Co, and hence to encourage good epitaxial growth, it is necessary to build up the layers while selecting the materials such that lattice parameters of the intermediate layer 104 and the underlayer 103 match the lattice parameters of the magnetic layer 105.

The drop in the dispersion of the c-axis orientation of the magnetic layer 105 due to the preferential orientation parallel to the substrate plane leads to a drop in the dispersion of the magnetic anisotropy, and hence it can be expected that there will be an increase in the coercivity and an increase in the stability to thermal fluctuation. On the other hand, the Co (101) planes are crystal planes that are inclined at approximately 30° C. to the c-axis, and hence these crystal planes being preferentially oriented would mean that the growth would occur with the c-axis inclined relative to the substrate. It is thought that this would inhibit the above-mentioned improvement in properties. To promote orientation of the c-axis parallel to the substrate plane, it is necessary to consider underlayer crystal planes on which Co (100) planes readily grow. Cr has a bee structure, and it is thought that the (211) planes correspond to such underlayer crystal planes. Here the lengths of the sides of the unit cell for the Cr (211) planes are as follows:

Cr (211) planes: short side 2.49 Å, long side 4.07 Å

These values are approximately the same as those for the Co (100) planes, and hence it is thought that good orientation of the c-axis parallel to the substrate plane can be realized. Note that the above-mentioned (211) orientation assumes an underlayer 103 of pure Cr and an intermediate layer 104 of pure Co, but similar effects can be achieved if an intermediate layer 104 having an hcp structure with lattice parameters larger than those for pure Co, and an underlayer 103 having a bee structure with lattice parameters larger than those for pure Cr are used accompanying the increase in the lattice parameters upon making the magnetic layer 105 be an alloy.

To preferentially orient the (211) planes of a bcc structure on the nonmagnetic substrate 101, it is thought that a B2 ordered alloy, for which there is a tendency for the two types of constituent element to be built up alternately on the substrate, is effective. With such a B2 ordered alloy, the interatomic bonds are strong, and hence it is thought that good orientation can be obtained even with a thin film. However, the film deposition is carried out without heating, and hence a deterioration in the orientation during the initial period of film deposition can be envisaged. It is thought that the thickness must be at least a certain value for an improvement in the orientation to be expected, but it is undesirable to make the thickness too high, since then an increase in grain size will be brought about. It is thus preferable to adopt the following layer structure to suppress an increase in grain size while maintaining good orientation:

A nonmagnetic substrate/a seed layer having a B2 structure with (211) orientation/an underlayer having bce structure with (211) orientation/a non-magnetic intermediate layer having hcp structure with (100) orientation/a CoCr alloy magnetic layer having hcp structure with (100) orientation.

In this case, the thicknesses of the seed layer 102, the intermediate layer 104, and the underlayer 103 are preferably not more than 20 nm to suppress an increase in grain size, although the optimum values of these thicknesses will differ depending on the materials.

Following is a description of the specific examples of the present invention. In the first example (Example 1), a CoZr seed layer of thickness 15 nm, a Ta underlayer of thickness 10 nm, and an Ru intermediate layer of thickness 15 nm were formed in this order on a plastic nonmagnetic substrate by a DC magnetron sputtering technique. Here, the sputtering conditions were made to be an Ar gas pressure of 5 mTorr and a film deposition power of 570W for the seed layer and the underlayer, and an Ar gas pressure of 70 mTorr and a film deposition power of 440W for the intermediate layer. Next, a (Co₇₀Cr₁₀Pt₂₀)−10SiO₂ magnetic layer of thickness 10 nm was formed by RF magnetron sputtering. Here, the sputtering conditions were made to be an Ar gas pressure of 5 mTorr and a film deposition power of 700W. Next, a diamond-like carbon protective layer of thickness 4 nm was formed by CVD. Then, a fluorocarbon-type liquid lubricant Z-dol (made by Ausimont) was applied to a thickness of 1.4 nm onto the protective layer, thus forming a lubricant layer.

Regarding the magnetic properties of the magnetic recording medium thus obtained, the coercivity Hc at a maximum applied magnetic field of 15 kOe was measured using a VSM (vibrating sample magnetometer, made by Riken Denshi Co., Ltd.). At the same time, the S/N ratio and the output attenuation were also measured.

Moreover, as a result of carrying out structural analysis under 40 kV-40 mA conditions using a Geigerflex (RAD-2C) made by Rigaku Corporation as an X-ray diffractometer, it was found that the (211) planes of the seed layer and the underlayer, and the (100) planes of the intermediate layer and the magnetic layer, were preferentially oriented parallel to the substrate plane of the nonmagnetic substrate.

In the first comparative example (Comparative Example 1), using an Al substrate having a 10 μm-thick NiP electroless plating film formed thereon as a nonmagnetic substrate, the nonmagnetic substrate was preheated to 200° C. A Cr seed layer of thickness 5 nmn, a CrMo₂₅ underlayer of thickness 5 nm, a CoCr₁₃Ta₄ intermediate layer of thickness 1.5 nm, and a CoCr₂₀Pt₁₂B₁₀ magnetic layer of thickness 15 nm were then formed in this order by DC magnetron sputtering. Here, the sputtering conditions were made to be an Ar gas pressure of 15 mTorr and a film deposition power of 500W. Other conditions were made to be as in Example 1, and a magnetic recording medium was thus produced. The coercivity He for the magnetic recording medium obtained were measured using a VSM as in Example 1. At the same time, the S/N ratio and the output attenuation were also measured.

Moreover, as a result of carrying out structural analysis under 40 kV-40 mA conditions using an X-ray diffractometer, it was found that the (200) planes of the seed layer and the underlayer, and the (110) planes of the intermediate layer and the magnetic layer, were preferentially oriented parallel to the substrate plane of the nonmagnetic substrate.

In the second comparative example (Comparative Example 2), using strengthened glass as a nonmagnetic substrate, the nonmagnetic substrate was preheated to 200° C. An NiAl seed layer of thickness 30 nm, a Cr underlayer of thickness 2 nm, a CrMo₂₅ underlayer of thickness 5 nm, a CoCr₁₃Ta₄ intermediate layer of thickness 1.5 nm, and a CoCr₂₀Pt₁₂B ₁₀ magnetic layer of thickness 12.5 nm were then formed in this order by DC magnetron sputtering. Here, the sputtering conditions were made to be as in Comparative Example 1. Other conditions were made to be as in Example 1, and a magnetic recording medium was thus produced. The coercivity He for the magnetic recording medium obtained was measured using a VSM as in Example 1. At the same time, the S/N ratio and the output attenuation were also measured.

Moreover, as a result of carrying out structural analysis under 40 kV-40 mA conditions using an X-ray diffractometer, it was found that the (110) planes of the seed layer and the underlayers, and the (100) planes of the intermediate layer and the magnetic layer, were preferentially oriented parallel to the substrate plane of the nonmagnetic substrate.

In the second example (Example 2), a magnetic recording medium was produced using the same conditions as in Example 1, except that an Al substrate having a 10 μm-thick NiP electroless plating film formed thereon was used as the nonmagnetic substrate. Again, the nonmagnetic substrate was not preheated. The coercivity He was measured using a VSM as in Example 1. At the same time, the S/N ratio and the output attenuation were also measured.

Moreover, as a result of carrying out structural analysis under 40 kV-40 mA conditions using an X-ray diffractometer, it was found that the (211) planes of the seed layer and the underlayer, and the (100) planes of the intermediate layer and the magnetic layer, were preferentially oriented parallel to the substrate plane of the nonmagnetic substrate.

In the third example (Example 3), a magnetic recording medium was produced using the same conditions as in Example 1, except that strengthened glass was used as the nonmagnetic substrate. Again, the nonmagnetic substrate was not preheated. The coercivity He was measured using a VSM as in Example 1. At the same time, the S/N ratio and the output attenuation were also measured.

Moreover, as a result of carrying out structural analysis under 40 kV-40 mA conditions using an X-ray diffractometer, it was found that the (211) planes of the seed layer and the underlayer, and the (100) planes of the intermediate layer and the magnetic layer, were preferentially oriented parallel to the substrate plane of the nonmagnetic substrate.

In the fourth example (Example 4), a magnetic recording medium was produced using the same conditions as in Example 1, except that the seed layer was made to be CuZr of thickness 15 nm. The coercivity He was measured using a VSM as in Example 1. At the same time, the S/N ratio and the output attenuation were also measured.

Moreover, as a result of carrying out structural analysis under 40 kV-40 mA conditions using an X-ray diffractometer, it was found that the (211) planes of the seed layer and the underlayer, and the (100) planes of the intermediate layer and the magnetic layer, were preferentially oriented parallel to the substrate plane of the nonmagnetic substrate.

In the fifth example (Example 5), a magnetic recording medium was produced using the same conditions as in Example 1, except that the intermediate layer was made to be WRh3 of thickness 15 nm. The coercivity He was measured using a VSM as in Example 1. At the same time, the S/N ratio and the output attenuation were also measured.

Moreover, as a result of carrying out structural analysis under 40 kV-40 mA conditions using an X-ray diffractometer, it was found that the (211) planes of the seed layer and the underlayer, and the (100) planes of the intermediate layer and the magnetic layer, were preferentially oriented parallel to the substrate plane of the nonmagnetic substrate.

In the sixth example (Example 6), a magnetic recording medium was produced using the same conditions as in Example 1, except that the underlayer was made to be W of thickness 5 nm, and the intermediate layer was made to be Re of thickness 15 nm. The coercivity He was measured using a VSM as in Example 1. At the same time, the S/N ratio and the output attenuation were also measured.

Moreover, as a result of carrying out structural analysis under 40 kV-40 mA conditions using an X-ray diffractometer, it was found that the (211) planes of the seed layer and the underlayer, and the (100) planes of the intermediate layer and the magnetic layer, were preferentially oriented parallel to the substrate plane of the nonmagnetic substrate.

In the seventh example (Example 7), a magnetic recording medium was produced using the same conditions as in Example 1, except that the magnetic layer was made to be (Co₆₀Cr₁₀Pt₃₀)−12SiO₂ of thickness 5 nm. The coercivity Hc was measured using a VSM as in Example 1. At the same time, the S/N ratio and the output attenuation were also measured.

Moreover, as a result of carrying out structural analysis under 40 kV-40 mA conditions using an X-ray diffractometer, it was found that the (211) planes of the seed layer and the underlayer, and the (100) planes of the intermediate layer and the magnetic layer, were preferentially oriented parallel to the substrate plane of the nonmagnetic substrate.

In the eight example (Example 8), a magnetic recording medium was produced using the same conditions as in Example 1, except that the seed layer was made to be CoTi of thickness 10 nm, the underlayer was made to be Mo of thickness 10 nm, and the intermediate layer was made to be Co3W of thickness 10 nm. The coercivity He was measured using a VSM as in Example 1. At the same time, the S/N ratio and the output attenuation were also measured.

Moreover, as a result of carrying out structural analysis under 40 kV-40 mA conditions using an X-ray diffractometer, it was found that the (211) planes of the seed layer and the underlayer, and the (100) planes of the intermediate layer and the magnetic layer, were preferentially oriented parallel to the substrate plane of the nonmagnetic substrate.

The results of the measurements of the coercivity He, the S/N ratio and the output attenuation for Examples 1 to 8 and Comparative Examples 1 and 2 are shown in the Figure.

THE TABLE

| | Coercivity | SNR | Output Attenuation |
|---|---|---|---|
| | [Oe] | [dB] | [%/decade] |
| Example 1 | 4180 | 13.7 | −0.29 |
| Comparative | 4080 | 13.1 | −0.72 |
| Example 1 | | | |
| Comparative | 3560 | 11.9 | −0.80 |
| Example 2 | | | |
| Example 2 | 3890 | 12.9 | −0.31 |
| Example 3 | 4097 | 12.5 | −0.30 |
| Example 4 | 4135 | 13.5 | −0.33 |
| Example 5 | 4200 | 13.2 | −0.29 |
| Example 6 | 4130 | 14.5 | −0.61 |
| Example 7 | 4235 | 14.7 | −0.32 |
| Example 8 | 4680 | 14.1 | −0.31 |

It can be seen from the Table above that the magnetic recording media of a nonmagnetic substrate, a seed layer formed on the nonmagnetic substrate and composed of a nonmagnetic material having a bee structure having (211) orientation, an underlayer formed on the seed layer and composed of a nonmagnetic material having a bcc structure that is different to that of the seed layer and having (211) preferential orientation, an intermediate layer formed on the underlayer and composed of a nonmagnetic material having an hcp structure having (100) preferential orientation, and a magnetic layer formed on the intermediate layer and composed of an hcp CoCr alloy having (100) preferential orientation, have a similar coercivity to or a higher coercivity than magnetic recording media manufactured using a conventional method that includes a substrate heating process, and moreover the S/N ratio and the thermal stability are improved.

As described above, according to the present invention, by selecting a material that readily undergoes (211) orientation as a seed layer, and then building up in order thereupon an underlayer, an intermediate layer, and a magnetic layer composed of materials having the most suitable lattice parameters, the degree to which the c-axis of the magnetic layer, which has Co as a principal component thereof, is oriented parallel to the substrate plane is improved. And it is possible to obtain a high coercivity, S/N ratio, and thermal stability without having to preheat the substrate. It thus becomes possible to achieve both a high S/N ratio and thermal stability, which are properties required of magnetic recording media nowadays. As a result, a storage device having a high information recording density and hence a high capacity can be realized.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

The disclosure of the priority applications, JP 2002-130143, in its entirety, including the drawings, claims, and the specification thereof, is incorporated herein by reference.

What is claimed is:

1. A magnetic recording medium comprising:
a nonmagnetic substrate;
a seed layer formed on the nonmagnetic substrate and composed of a nonmagnetic material having a bcc structure having (211) orientation;
an underlayer formed on the seed layer and composed of a nonmagnetic material having a bcc structure that is different to that of the seed layer and having (211) preferential orientation;
an intermediate layer formed on the underlayer and composed of a nonmagnetic material having an hcp structure having (100) preferential orientation; and
a magnetic layer formed on the intermediate layer and formed of an hcp CoCr alloy having (100) preferential orientation.

2. The magnetic recording medium according to claim 1, wherein the bcc structure of the seed layer is a B2 structure.

3. The magnetic recording medium according to claim 1, wherein the seed layer has a thickness of 1 to 30 nm.

4. The magnetic recording medium according to claim 2, wherein the seed layer has a thickness of 1 to 30 nm.

5. The magnetic recording medium according to claim 1, wherein the nonmagnetic substrate is a substrate selected from the group consisting of NiP-plated Al substrates, glass substrates, and plastic substrates.

6. The magnetic recording medium according to claim 4, wherein the nonmagnetic substrate is a substrate selected from the group consisting of NiP-plated Al substrates, glass substrates, and plastic substrates.

7. The magnetic recording medium according to claim 1, wherein the underlayer comprises a nonmagnetic alloy having as a principal component thereof at least one element selected from the group consisting of Ta, Nb, V, Mo, Cr, Ti, W, and Mn.

8. The magnetic recording medium according to claim 6, wherein the underlayer comprises a nonmagnetic alloy having as a principal component thereof at least one element selected from the group consisting of Ta, Nb, V, Mo, Cr, Ti, W, and Mn.

9. The magnetic recording medium according to claim 1, wherein the seed layer has as a principal component thereof an intermetallic compound selected from the group consisting of CoHf, CoSc, CoTi, CoZr, CuZr, CuSc, MgRh, FeTi, FeRh, NiSc, NiTi, and RuZr.

10. The magnetic recording medium according to claim 8, wherein the seed layer has as a principal component thereof an intermetallic compound selected from the group consisting of CoHf, CoSc, CoTi, CoZr, CuZr, CuSc, MgRh, FeTi, FeRh, NiSc, NiTi, and RuZr.

11. The magnetic recording medium according to claim 1, wherein the intermediate layer has as a principal component thereof at least one element selected from the group consisting of Ru, Re, Os, and Tc.

12. The magnetic recording medium according to claim 10, wherein the intermediate layer has as a principal component thereof at least one element selected from the group consisting of Ru, Re, Os, and Tc.

13. The magnetic recording medium according to claim 1, wherein the intermediate layer has as a principal component thereof an intermetallic compound of a composition selected from the group consisting of WRh3, Ni3Sn, Ni3Zr, Co3W, NiIn, TiAl, Co3C, CuZn, and MnZn.

14. The magnetic recording medium according to claim 10, wherein the intermediate layer has as a principal component thereof an intermetallic compound of a composition selected from the group consisting of WRh3, Ni3Sn, Ni3Zr, Co3W, NiIn, TiAl, Co3C, CuZn, and MnZn.

15. The magnetic recording medium according to claim 1, wherein the magnetic layer has a CoCr alloy as a principal component thereof, contains 5 to 20% of a nonmetallic element or a nonmetallic compound as a molar ratio relative to Co, and contains 10 to 50% of Pt as an atomic ratio relative to Co.

16. The magnetic recording medium according to claim 12, wherein the magnetic layer has a CoCr alloy as a principal component thereof, contains 5 to 20% of a nonmetallic element or a nonmetallic compound as a molar ratio relative to Co, and contains 10 to 50% of Pt as an atomic ratio relative to Co.

17. The magnetic recording medium according to claim 14, wherein the magnetic layer has a CoCr alloy as a principal component thereof, contains 5 to 20% of a nonmetallic element or a nonmetallic compound as a molar ratio relative to Co, and contains 10 to 50% of Pt as an atomic ratio relative to Co.

18. A method of manufacturing a magnetic recording medium, comprising the steps of:
forming, on a nonmagnetic substrate, a seed layer of a nonmagnetic material having a bcc structure that has (211) orientation;
forming, on the seed layer, an underlayer of a nonmagnetic material having a bcc structure that is different to that of the seed layer and having (211) preferential orientation;
forming, on the underlayer, an intermediate layer of a nonmagnetic material having an hcp structure that has (100) preferential orientation; and
forming, on the intermediate layer, a magnetic layer of an hcp CoCr alloy that has (100) preferential orientation.

19. The method of manufacturing a magnetic recording medium according to claim 18, wherein at least one of the steps of forming the seed layer, underlayer, intermediate layer, and magnetic layer is carried out without heating the nonmagnetic substrate.
